(19) United States
(12) Patent Application Publication
(10) Pub. No.: US 2013/0230012 A1
(43) Pub. Date: Sep. 5, 2013

(54) DETERMINING A MOBILE COMMUNICATIONS NETWORK CELL FREQUENCY

(71) Applicant: Dietmar Lipka, Berg (DE)

(72) Inventor: Dietmar Lipka, Berg (DE)

(73) Assignee: TELEFONAKTIEBOLAGET L M ERICSSON (PUBL), Stockholm (SE)

(21) Appl. No.: 13/884,718

(22) PCT Filed: Nov. 12, 2010
(86) PCT No.: PCT/EP2010/067396

§ 371 Date: May 10, 2013

(51) Int. Cl. H04W 48/16

(52) U.S. Cl. CPC H04W 48/16
USPC 370/329

(57) ABSTRACT

The invention refers to supporting a cell search within a cellular communications network by evaluating a radio signal received from the network, the radio signal covering a certain frequency range composed of a plurality of frequency bands, wherein each band is associated to a certain carrier frequency, the method comprising generating (204) a set of digital signals associated to different carrier frequencies by demodulating the radio signal, evaluating (206) each of the set of digital signals in order to detect a presence of a recurring signal component with a known property, and selecting a corresponding cell, and synchronizing (210) to the carrier frequency associated to the selected cell.

### TECHNICAL FIELD

The present invention generally relates to mobile communications, and specifically to determining cell characteristics.

### BACKGROUND

In multi-transmitter communications networks, channel access techniques allow multiple transmitters connected to the same physical channel to share its transmission capacity. Various such channel access techniques are known in the art. For example, in second generation communications systems according to the Global System for Mobile communications (GSM) standard, Time Division Multiple Access (TDMA) techniques are utilized to divide a specific frequency channel into individual time slots assigned to individual transmitters. In third generation communications systems, Code Division Multiple Access (CDMA) techniques divide channel access in the signal space by employing a combination of spread spectrum operations and a special coding scheme in which each transmitter is assigned an individual code.

The next advance in wireless communications systems considers Orthogonal Frequency Division Multiple Access (OFDMA) techniques for the radio downlink to achieve still higher bit rates. Corresponding advanced mobile networks are specified under a term called Long Term Evolution (LTE) within the Third Generation Partnership Project (3GPP). Within OFDMA, a large number of closely-spaced orthogonal sub-carriers are used to carry the communication data. This data are divided into several parallel data streams or channels, one for each sub-carrier. The sub-carrier frequencies are chosen so that the sub-carriers are orthogonal to each other, so that cross-talk between the sub-channels is avoided. The orthogonality allows for efficient modulation and demodulation implementation using an algorithm called Fast Fourier Transformation (FFT) on the receiver's side, and a corresponding Inverse FFT on the sender's side. According to current 3GPP specifications, the downlink is subdivided into sub-frames consisting of e.g. 14 OFDM symbols which are composed of equally spaced modulation symbols respectively sub-carriers or resource elements. 12 resource elements in 7 OFDM symbols are combined into basic units being referred to as resource blocks. This establishes a two dimensional grid in frequency and time, where the OFDM symbols represent the frequency dimension and their sequence the time dimension. As actually defined by 3GPP, the sub-carrier spacing in the OFDM downlink is 15 kHz, wherein a maximum of 1200 sub-carriers is available.

Before any terminal can communicate with the network, upon activation, it has to detect a cell and synchronize to that cell, and further to decode cell system information needed to be able to communicate within the cell. Such process is being referred to as cell search. The cell search procedure might comprise an initial search for center frequencies of downlink signals of surrounding cells.

A cell frequency scan in existing systems like wide-band code division multiplex access (WCDMA) systems e.g. used in UMTS and time division multiplex access systems e.g. used in GSM is known to use essentially the received signal strength indication (RSSI), i.e. measurements of the total received power of a signal. This is suitable as an essential amount of the signal power is constant over the time in such systems. In GSM, the power during received bursts is constant, in WCDMA more than half of the total power is composed of broadcast channels with constant levels. Consequently, the total power or RSSI does not vary or only varies moderately.

However, in cellular communication systems employing a dynamic resource allocation and thus exhibiting a significant variation of the signal power over the time, the RSSI method does not work sufficiently. Applying such method e.g. to LTE might regularly lead to wrong center frequencies, as within LTE, resource allocation in LTE is dynamically performed by assigning for each sub-frame a certain number of resource blocks to each user equipment or mobile terminal, and consequently signal power might vary between almost zero to a maximum value. Furthermore the spectrum of an LTE cell may have one out of different bandwidths (e.g. between 1.4 MHz and 20 MHz as currently specified by 3GPP).

### SUMMARY

It is an object of the present invention to provide a cell frequency detection being suitable for systems exhibiting a significant variation of the signal power e.g. due to a dynamic resource allocation.

This object is achieved by the independent claims. Advantageous embodiments are described in the dependent claims.

It is an idea of this invention is to use a component with known properties within the downlink signal from the network to the mobile terminal having known properties.

In an embodiment, a cell frequency of an appropriate cell is detected by the mobile terminal by evaluating a downlink radio signal sent by the network, wherein the radio signal comprises a recurring, e.g. a periodic signal component with a known property. A set of digital sequences associated to different cell identities of the radio signal is generated and each of the set of digital sequences is evaluated in order to detect the signal component with known property. After a detection of the signal component within one of the digital sequences, as synchronization to the corresponding carrier frequency might be performed.

The invention provides an easy process of detecting a center frequency of any cell to be synchronized even in cases of dynamic resource allocation with respect to time and/or frequency. The invention allows identifying the position of the known component in time and frequency without any system knowledge of the cell.

In an embodiment, the known property is a known structure of digital data comprised by the signal component such that it can be detected by means of a correlation with defined digital data. The defined digital data might comprise one defined digital sequence or a set of defined digital sequences.

In an embodiment, the known structure of the digital data is a defined digital sequence, or is a presence of one of a plurality of defined digital sequences, e.g. a presence of one out of three digital sequences.

In an embodiment, each of the set of digital sequences is scanned by means of a correlation with the one or the plurality of defined digital sequences of the signal component to obtain a corresponding set of evaluation results. The evaluation results might exhibit correlation peaks (e.g. associated to correlation values above a pre-defined value). Each cell associated to a correlation peak might be stored as a cell candidate. At least one of the carrier frequencies might be selected by applying a certain selection criterion to the evaluation results.

In an embodiment, the correlation peak value is used as a quality criterion for selecting one of a plurality of the cell candidates. This criterion might be to select a maximum peak or a maximum peak out of pre-selected cell candidates or all peak values above a threshold.

In an embodiment, a controller tunes a radio receiver of the mobile terminal stepwise through a defined set of frequencies that might be the center frequencies of a cell. The receiver stays on each frequency at least for a time interval that ensures at least one occurrence of the known signal component. During that time the signal is correlated with the one or the plurality of possible sequences associated to the known signal component. The detected magnitude of all correlation peaks might be recorded. Afterwards, a suitable cell may be selected based out of the recoded magnitudes.

These set of frequencies to be stepped through might be taken from a list of pre-defined cells, e.g. of a-priori known preferred cells. Alternatively, this set of frequencies might be associated to cells found during a previous activation of the UE. In a further alternative, this set of frequencies might be denoted by a certain frequency raster (e.g. 100 KHz) as currently defined by 3GPP) of a certain frequency band (e.g. between 2620 and 2690 MHz in case of band 7). In a further alternative, the set of frequencies to be evaluated might be derived from any combination of the above methods.

In an embodiment the communications network compliant with the LTE or LTE-Advanced standards as specified by above-mentioned 3GPP.

In an embodiment, certain periodic resource elements at pre-defined positions in the downlink resource grid being reserved for synchronization and reference signaling are used for the cell frequency determination. One of such elements that might be chosen as known signal component is the so-called Primary Synchronization Signal (P-SS) being specified to perform a first step to cell-search in order to detect a first (rough) timing grid. According to 3GPP standard 36.211 (actual version 9.1.1.), the P-SS occupies 72 resource elements located in a frequency range of about 1 MHz in the centre of the downlink signal spectrum. It occurs periodically (every 5 ms) in for example the 5^{th} and 6^{th} OFDM symbol in slot 0 and 10 and shares its spectrum with resource elements carrying data. The P-SS sequence might be one out of three possible predefined sequences (depending on the cell identity) being generated from a so-called frequency-domain Zadoff-Chu sequence. A Zadoff-Chu sequence is a so-called Constant Amplitude Zero Auto-Correlation—CAZAC-sequence comprising complex-valued symbols (also called samples) which, when modulated onto a radio carrier, gives rise to an electromagnetic signal of constant amplitude, whereby cyclically shifted versions of the sequence comprising the signal do not (at least essentially not) cross-correlate with each other when the signal is recovered at the receiver.

During an initial cell scan, the terminal is not synchronized to any cell, and thus the receiver frequency might be deteriorated by a certain frequency offset. Due to the property of Zadoff-Chu sequences used as P-SS a frequency offset does not suppress its magnitude but only causes a time shift of the correlation peak. Thus, a cell scan based on such sequence will be insensitive to typical frequency offsets of the receiver due to a free-running reference oscillator.

The present invention also concerns computer programs comprising portions of software codes in order to implement the method as described above when operated by a respective processing unit of a user device and a recipient device. The computer program can be stored on a computer readable medium. The computer-readable medium can be a permanent or rewritable memory within the user device or the recipient device or located externally. The respective computer program can be also transferred to the user device or recipient device for example via a cable or a wireless link as a sequence of signals.

In the following, detailed embodiments of the present invention shall be described in order to give the skilled person a full and complete understanding. However, these embodiments are illustrative and not intended to be limiting.

### BRIEF DESCRIPTION OF THE FIGURES

FIG. 1 shows an exemplary block diagram of a receiver part of a mobile terminal for determining a cell frequency based on radio signal received from a cellular communications network,

FIG. 2 shows an exemplary sequence of steps to be performed by the receiver part of FIG. 1, and

FIG. 3 shows a more detailed block diagram of an embodiment of the receiver part.

### DETAILED DESCRIPTION

In the following description of preferred embodiments, for purposes of explanation and not limitation, specific details are set forth (such as particular signal processing components and sequences of steps) in order to provide a thorough understanding of the present invention. It will be apparent to one skilled in the art that the techniques described herein may be practiced in other embodiments that depart from these specific details. For example, while the following embodiments will primarily be described in context with an OFDM-based receiver stage, the present invention may also be implemented in other receiver stages e.g. employing time division or code division multiplexing. While the embodiments relate to an exemplary LTE implementation, it will be readily apparent that the techniques described herein may also be implemented in other mobile and stationary communications networks (such as LTE-Advanced networks).

Moreover, those skilled in the art will appreciate that the services, functions and steps explained herein below may be implemented using software functioning in conjunction with a programmed microprocessor, an Application Specific Integrated Circuit (ASIC), a Digital Signal Processor (DSP) or a general purpose computer. It will also be appreciated that while the following embodiments will primarily be described in context with methods and devices, the invention may also be embodied in a computer program product as well as in a system comprising a computer processor and a memory coupled to the processor, wherein the memory is encoded with one or more programs that may perform the services, functions and steps disclosed herein.

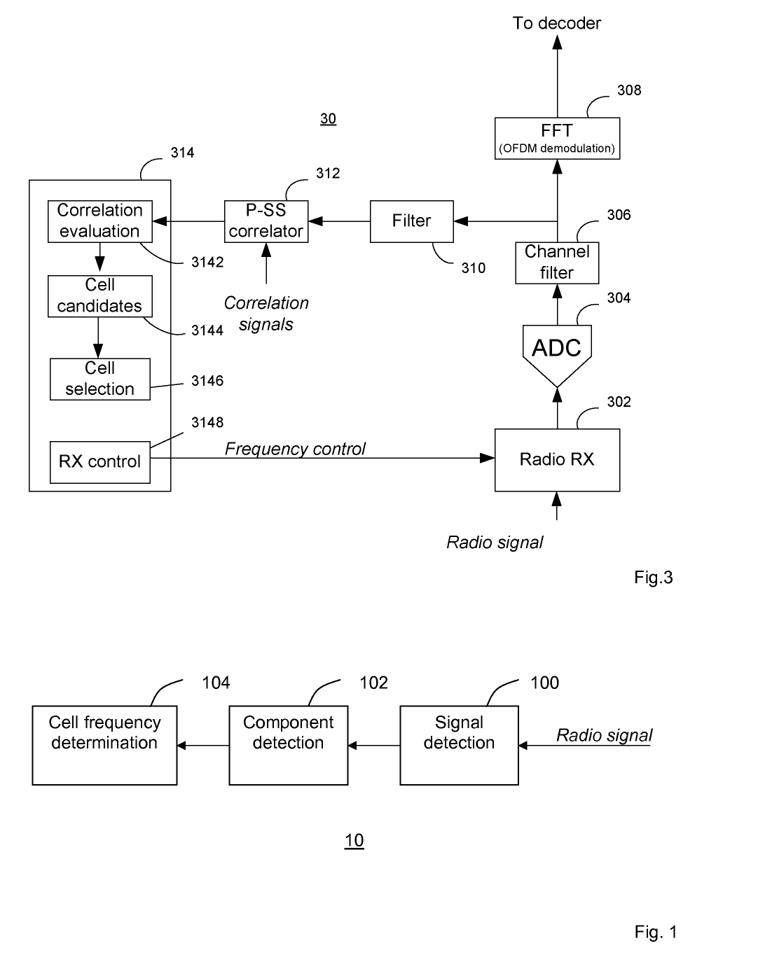

FIG. 1 shows a block diagram of a principle receiver stage 10 that might be integrated in a user terminal of a mobile communications network. The user terminal may be a stand-alone mobile telephone or may be incorporated, for example as a network card or data stick, in a stationary or portable computer. By way of example, the receiver stage 10 comprises a signal detection circuit 100, a signal component detection circuit 102 and a cell frequency determination circuit 104. The signal detection circuit 100 receives a radio signal from a cellular communications network, whereby the radio signal covers a certain frequency range composed of a plurality of frequency bands. The frequency bands might be each associated to a different carrier or sub carrier frequency. The radio signal might comprise a known signal component repeatedly inserted into one or a plurality of the different carrier signals. This signal component might be periodically inserted into the signal of certain carrier frequencies, e.g. a so-called synchronization signal.

The signal detection circuit 100 generates from the received radio signal a set of different digital sequences each associated to a different carrier frequency. The set might comprise the signals associated to the carrier frequencies within the frequency range of the radio signal. Alternatively, the set might comprise signals associated to pre-selected frequencies (e.g. being stored in the mobile terminal from previous cell searches. The set of digital sequences is provided to the component detection circuit 102 that evaluates the different sequences to detect the known signal component. Thereto, the detection circuit might perform a correlation of the signal component with all the sequences of the different carrier signals. If a correlation results show a peak it can be assumed that the component was present in the signal. A peak might be detected by comparing the correlation result with a certain threshold.

The correlation results are provided to the cell frequency determination circuit 104. The cell frequency determination circuit 104 performs an identification of correlation peaks occurring in the correlation results in order to identify appropriate cell candidates. Thereto, each correlation peak above a certain threshold might be identified, and corresponding cells might be treated as cell candidates. The cell frequency determination circuit 104 might store the carrier frequencies associated to the detected peaks as candidate frequencies, and might select one out of the candidate frequencies as actual cell frequency to be synchronized to.

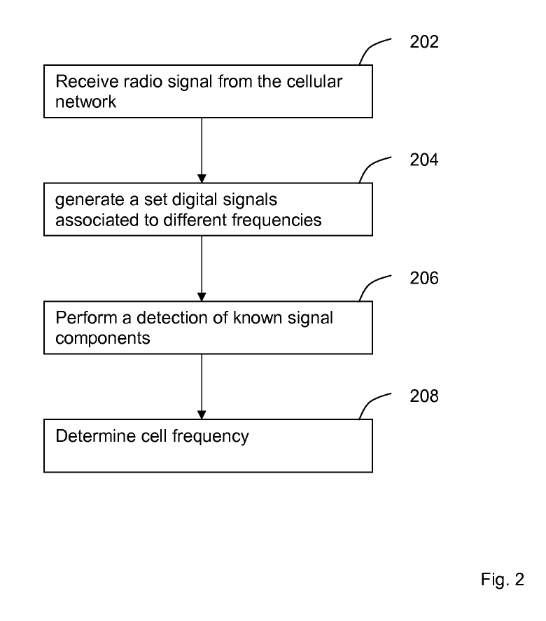

FIG. 2 shows a process with an exemplary sequence of steps for detecting a carrier frequency according to FIG. 1. In a first step 202, a radio signal is received from the network. In a second step 204, a set of digital signals (or sequences) each associated to one of a set of different carrier frequencies is generated. In a third step 206, each digital signal out of the set of digital signals is examined in order to detect a presence of the known signal component. In a fourth step 208 a carrier frequency of a selected is determined to be used for cell synchronization. This step might comprise selecting one cell out of a plurality of cell candidates associated to each a digital signal that has been identified to comprise the known signal component corresponding to the above description.

In the following embodiments, an exemplarily initial carrier frequency determination process will be described in more details, using the primary synchronization sequence P-SS of an LTE-compliant communications network. The signal content of the P-SS, its generation in the access network and its mapping to resource elements can be drawn from section 6.11.1 of 3GPP TS 36.211.

FIG. 3 shows an exemplary block diagram of a receiver stage 30 By way of example, the receiver stage 30 comprises a Radio Frequency (RF) receiver 302 configured to receive a downlink signal (including the embedded P-SS) from the access network and to down-convert the downlink signal to baseband frequency. The receiver stage 30 further comprises an analog/digital converter 304 coupled to an output of the receiver 302 and a channel filter 306 coupled to an output of the analog/digital converter 304. An OFDM demodulator 308 is coupled to an output of the channel filter 306 to perform the conventional OFDM demodulation operation. The demodulation operation and the subsequent processing steps will not be discussed further here.

In addition to the OFDM processing branch, a further processing branch capable cell frequency determination taps the output of the channel filter 306. This further signal processing branch comprises an optional filter 310 and a P-SS correlator 312 having a first input coupled to an output of the filter 312. The P-SS correlator 312 additionally has a second input to receive a plurality of correlation signals according to the plurality of sequences dᵤ(n) is used for P-SS:

As discussed above, in current LTE, the P-SS is located in a frequency range of about 1 MHz in the center of the downlink signal spectrum, and the period of the P-SS is 5 ms. One out of three predefined sequences dᵤ(n) is used for P-SS. The sequences dᵤ(n) are generated from a frequency-domain Zadoff-Chu sequence according to the following equations:

$${d}_{u} ( n ) = \{ \begin{matrix}{e}^{- j \frac{π un ( n + 1 )}{63}} & n = 0 , 1 , … , 30 \\ {e}^{- j \frac{π u ( n + 1 ) ( n + 2 )}{63}} & n = 31 , 32 , … , 61\end{matrix}$$

with u denoting the Zadoff-Chu root sequence index (being one value out of the values 25, 29 or 34 according to 3GPP TS 36.211, Section. 6.11.1.1).

A control unit 314 is coupled to an output of the P-SS correlator 312 and configured to control the operation of the cell search. Thereto, the control unit 314 comprises the following functional units:

A correlation evaluation unit 3412 receives the correlation results and detects in each of the results correlation peaks indicative of a presence of one of the P-SS sequences within the corresponding received signals.

A cell candidate determination unit 3144 selects and stores each cell associated to a correlation peak determined by the correlation evaluation unit 3412.

A cell selection unit 3146 selects a suitable cell out of the cell candidates determined by the cell candidate determination unit by applying certain selection criteria as discussed above.

A receiver controller 3148 generates a control signal for tuning the receiver 302 stepwise through frequencies within a certain frequency range that might be the center frequency of a cell. These frequencies might be taken from a list of a-priori known preferred cells, or cells found during a previous activation of the terminal, or simply frequency of a frequency raster of a certain band. According to current 3GPP specifications, the LTE frequency raster has a step size of 100 KHz. While tuning the receiver 302 stepwise through frequencies, the receiver might be controlled to stay on each frequency at least for a minimum time interval that ensures the occurrence of at least one P-SS. Within that time, the signal is correlated by the P-SS correlator 312 with all three P-SS sequences.

It is to be noted that during cell scan the UE is not synchronized to any cell. The receiver frequency might thus deteriorated by a certain frequency offset. The above-described cell scan based on correlation with the P-SS is insensitive to frequency offsets. This is due to the property of the Zadoff-Chu sequence used as P-SS that a frequency offset causes a time shift of the correlation peak but does not suppress its magnitude. In other words a correlation peak will occur despite any frequency offset.

1. A method of supporting a cell search within a cellular communications network by evaluating a radio signal received from the network, the radio signal covering a certain frequency range composed of a plurality of frequency bands, wherein each band is associated to a certain carrier frequency, the method comprising:
generating a set of digital signals associated to different carrier frequencies by demodulating the radio signal,
detecting a presence of a recurring signal component with a known property within one digital signal out of the set of digital signals, and
determining a carrier frequency associated to said one signal to be used for cell synchronization.

2. The method of claim 1, wherein the known property is a known structure of digital data comprised by the signal component such that it can be detected by means of a correlation with defined digital data.

3. The method of claim 2, wherein the defined digital data comprises one defined digital sequence or a set of defined digital sequences.

4. The method of claim 3, wherein the defined digital sequences are so-called Constant Amplitude Zero Auto-Correlation—CAZAC-sequences.

5. The method of claim 3, wherein the set of defined digital sequences comprises three Zadoff-Chu sequences according to
$${d}_{u} ( n ) = \{ \begin{matrix}{e}^{- j \frac{π un ( n + 1 )}{63}} & n = 0 , 1 , … , 30 \\ {e}^{- j \frac{π u ( n + 1 ) ( n + 2 )}{63}} & n = 31 , 32 , … , 61\end{matrix}$$
with u being 25, 29 and 34.

6. The method of claim 3, wherein the step of detecting comprises performing a correlation of the one defined digital sequence or of each one of the set of defined digital sequences with each one of the set of digital signals associated to the different carrier frequencies.

7. The method of claim 6, wherein the step of detecting comprises establishing a detection threshold, determining for each correlation result whether it comprises a peak value exceeding the detection threshold, and establishing a corresponding set of cell candidates.

8. The method of claim 7, wherein the step of determining comprises selecting one cell out of the plurality of cell candidates based on a magnitude evaluation of the corresponding peak values.

9. The method of claim 8, wherein selecting the one cell out of the plurality of cell candidates is performed by one of:
selecting a maximum peak value out of the peak values, and
selecting a maximum peak value out of the peak values of pre-selected cell candidates.

10. The method of claim 1, wherein step of generating comprises sequentially tuning a radio receiver for receiving the radio signal to a set of different frequencies.

11. The method of claim 10, wherein the radio receiver is tuned by stepwise increasing or decreasing the frequency within a certain frequency range.

12. The method of claim 10, wherein the set of different frequencies are associated to a set of pre-defined cells, preferably form a set of a-priori known cells or from cells identified during a previous cell search.

13. The method of claim 1, wherein the cellular network is compliant with the LTE or LTE-Advanced standards as established by the Third Generation Partnership Project.

14. A mobile terminal for evaluating a radio signal received from the network, the radio signal covering a certain frequency range composed of a plurality of frequency bands, wherein each band is associated to a certain carrier frequency, the terminal comprising:
an processor adapted for generating a set of digital signals associated to different carrier frequencies by demodulating the radio signal,
detection circuit adapted for evaluating each of the set of digital signals in order to detect a presence of a signal component with a known property, and selecting a corresponding cell, and
a cell frequency determination circuit adapted for determining the carrier frequency associated to the selected cell to be used for cell synchronization.

15. A computer program loadable into a mobile terminal, the computer program comprising code adapted to execute the method of claim 1.
